(19) United States
(12) Patent Application Publication
(10) Pub. No.: US 2003/0213844 A1
(43) Pub. Date: Nov. 20, 2003

(54) Product marked with product code, product information inquiry system, product information inquiry device and POS system

(76) Inventors: Shigeji Yoshida, Toyonaka-shi (JP); Kanichi Hasegawa, Sapporo-shi (JP); Seiichiro Tamai, Toyono-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/232,680

(22) Filed: Sep. 3, 2002

(30) Foreign Application Priority Data
May 20, 2002 (JP) 2002-144852

(51) Int. Cl. G06K 15/00

(52) U.S. Cl. 235/383

(57) ABSTRACT

A product code includes an item code 30a, an individual article code 30b and a detail code 30c. The item code 30a is a code specifying an item to which the product belongs, such as a JAN code. The individual article code 30b is a code identifying the product uniquely, such as a bar code indicating a lot number or a serial number marked on the product at the time of manufacturing. The detail code 30c is a code indicating detail information of the product including information about the sources of the product, and component parts, raw materials or ingredients of the product. The detail code 30c is, for example, a two-dimensional code describing parts and raw materials, a production place and feed and chemicals used in the raising process if the product is livestock meat or cultivated fish, etc., and chemical fertilizers and pesticides used for the ingredients if the product is food, as the detail information of the product according to MRP.

### BACKGROUND OF THE INVENTION

(1) Field of the Invention

The present invention relates to a product which is marked with a product code such as a bar code, a product information inquiry system and a POS (Point-of-Sale) system based on the product code, and more particularly, to a product code and others which help disclose detail information of the product.

(2) Description of the Related Art

There are product codes in use for a POS system such as a JAN (Japan Article Number) code and a UPC (Universal Product Code). The JAN code is a bar code having 13 digits symbols including a 2-digit country of origin code, a 5-digit manufacturer code, a 5-digit item code and a 1-digit check code, as shown in FIG. 22.

Use of the current product code represented by the JAN code enables product management by item. For example, it makes possible to determine a price corresponding to an item of a product at the point of sale, or to manage quantity of the product by item.

However, the current product code just specifies an item, and cannot classify the product into individual articles. As a result, there is a problem that the current POS system can do no more than manage the product by item, and cannot manage the product by individual article in consideration of its own characteristic.

For example, cartons of milk are different in the use-by date and arrival date although they all belong to the same item. Consumers choose and purchase one that has the latest use-by date, that is, the latest arrival date from among the same item of products. Therefore, the products which have lost their freshness remain unsold. However, since the current POS system cannot grasp the unsold products, a sales person has to take inventory of an enormous amount of products.

There is also a problem of mismatched classification that the product code such as a JAN code may not classify products in the POS system though consumers classify them. That is, there occurs mismatching of a classification unit between that classified by consumers at their purchase and that classified by the POS system.

Assume that there are three colors of towels, white, yellow and blue, of an item A, for example. Even if consumers buy blue ones, they cannot be classified on the POS data. It is regarded that towels of the item A were sold, regardless of the colors. The towels of the item A are ordered based on the POS data.

As a result, blue towels which sell in various stores in common are more likely to be out of stock of the manufacturer. If the stores order the towels without specifying their colors, white and yellow towels which the manufacturer has in stock are delivered according to the number of sales results even though they do not sell. The stores are short of the blue ones which sell well. Then, it is judged that the towels of the item A have not sold although the blue ones actually sell well. In sum, reasonable ordering using POS sales data and real time inventory, such as CAO (Computer Assisted Ordering), cannot be made.

By the way, a scandal has recently happened in Japan that a certain food company has mislabeled origins of meat for sale in connection with a mad cow disease problem. We cannot brush off this scandal just as a case where a part of employees of the food company has performed a criminal act for achieving the sales quota. We should consider that this case was caused by the following problems.

First, it was easy to mislabel origins of meat, and persons other than those concerned cannot find the mislabeling because there is no comprehensive management system. Second, consumers today appreciate food from undoubted production place, that is, of identified ancestral registry.

Therefore, it is extremely important as fundamental solutions to (1) establish a distribution system causing no problem, and (2) have a system enabling to identify a cause of a problem quickly.

The cause of the mad cow disease was meat-and-bone meal made of affected beef among feed for cows. Consumers have the right to know not only origins of cows but also what kind of feed the cows have eaten and what type of antibiotics and chemicals have been used for the cows. This problem would be more and more serious. Even if we get such information, problems of drug-induced diseases, plagues, feed and antibiotics cannot be solved. However, information about sources of products has to be disclosed in detail, and consumers need to know them before buying them. Chain stores having a social mission is responsible for disclosing their product information ahead of other industries.

For that purpose, information must be disclosed to consumers in corporation with like-minded manufacturers by constructing a visible condition of sources, ingredients, components, parts and raw materials using computer database in the store. And a technical scheme is required for facilitating companies to join social action programs.

Recently, problems have also emerged with globalization of distribution. Today a finished product is made of a mixture of parts from around the world, so there is no sense in indicating a country of origin of the finished product. It is necessary to make the parts and raw materials of one product visible for indicating its origin accurately.

This is true for not only imported goods but also domestic ones. For example, although various feed, fertilizers, antibiotics, chemicals, etc. are used for one food in processes of growing and farming, such information is not necessarily disclosed to consumers. Therefore, they feel anxiety about undisclosed source of the food. It is supposed, in the wake of the above-mentioned food scandal, that an increasing number of consumers will appreciate disclosed sources of foods.

### SUMMARY OF THE INVENTION

The present invention has been accordingly made in consideration of the above problems, and it is the object of the present invention to provide a technical scheme to support construction of a distribution system for disclosing a source of a product (i.e., a new product code system and a system for managing a product marked with the product code, specifically). Thereby, it makes possible to optimize environment-friendly and efficient production, sales, uses, services and recycling, and manage the source of the product around the world in a comprehensive manner.

In other words, it makes possible to make a source of a product visible by making public the attributes of the components of the product, with the finished product for final consumption as a starting point, (that is, to trace back to inventory, manufacturing, manufacturing parts, components and resources). Furthermore, it makes possible to optimize management of the product through its life cycle, with the finished product as a starting point, such as expansion of buyer's selection (i.e., increase of opportunities for consumers to select and buy better ones), response to quality requested by the marketplace, extension of product life, easy repair of parts and services, and easy recycling.

In order to achieve the above object, the product code according to the present invention is not a product code for each sales store but a product code that is uniformly source-marked at the product manufacturing or delivery stage, the product code including an item code for specifying an item of the product; and an individual article code for identifying the product uniquely among a group of products belonging to the same item. Here, “source marking” means that giving a code to a product at an upper stage (such as a manufacturing stage or a wholesale stage) than the final retail stage.

This source-marked product code does not include information depending upon retail stores at the final stage of product sales, but includes identification information which enables to specify the product uniquely in the world, and thereby, enables to manage products per individual article, not per item. If each product is recorded together with the corresponding information which specifies a position of the product placed on the distribution, a manager, etc., for example, it becomes possible to grasp the present situation and the past route of each product in the process of the distribution quickly, and therefore, it becomes possible to optimize the efficient production, sales, use, service and recycling, and manage the global resources as a whole.

Here, the product code according to the present invention may include a detail code for specifying details of the product, in addition to the above-mentioned item code and the individual article code.

More specifically, the product code according to the present invention (hereinafter also referred to as a “URC” (Universal Resource Code)) may be the product code that:

(1) includes a function of managing items like a JAN code and UPC,

(2) indicates manufacturing lots and serial numbers (individual article numbers) of products of the same item, and

(3) enables to expand into an open MRP (Material Requirement Program) including the detail information of the product.

For example, the URC is the product code that:

(1) is the current JAN code,

(2) to which an individual article code (a serial number) is added as a bar code, and

(3) which describes, as detail information of the product, parts and ingredients or raw materials, a production place and feed and chemicals used in the breeding process if the product is livestock meat or cultivated fish, etc., and chemical fertilizers and pesticides used for the ingredients and a processing method if the product is food.

This product code is compatible, that is, it can be used for both the current POS system that can read only the JAN code and the POS system (such as a network centric POS system) that manages individual articles.

A two-dimensional code is used for detail information of a product because it is copious. A customer himself displays the information on a screen so as to read it using a two-dimensional code scanner set in a store. The content of this detail information is determined in cooperation and under an agreement with a manufacturer who has a mind to disclose its product information.

As a result, both the product that discloses its detail information and the product that does not disclose it are placed in the same store. Which product do consumers purchase, the product that discloses its detail information or the product that does not disclose it? The answer to this question makes the manufacturers to disclose the detail information of their products. Consumers have the initiative.

The content of the detail information, detailed or simple, is also left to the manufacturers' judgment. Information constitutes added value of a product. The less the product discloses information, the more it loses its added value.

It is a new voluntary standardization technique to incorporate this self-inspiring action. This is a new attempt beyond a regulatory framework such as JAS under the exclusive control of bureaucracy.

The URC (Universal Resource Code) according to the present invention has a tree structure in which a product (food or an industrial product) develops into parts, members, raw materials, ingredients, breeding, feed, chemicals, pesticides, and processing processes.

For example, a notebook computer, which is a final product (item) according to the JAN classification, is further classified into its parts and raw materials according to the URC system.

A product can be developed into its parts and raw materials according to the URC system. A supply chain can be traced back not only to a level of an item that is a finished product as a final product, but also to an individual article, and further to its parts, raw materials and resources.

Comprehensive management of resources using the URC database is the URM (Universal Resource Management). This opens the way for the global resource management.

According to the URM, when a product sold and consumed at a store is replenished;

(1) the product and its raw materials and others at the most upstream are organized, and therefore,

(2) they are ordered by tracing back to the inventory of the raw materials, resources and processing of the product, in line.

As mentioned above, the present invention can be realized not only as a characteristic product code that enables universal resource management, but also as a product label on which this product code is printed, a noncontact IC tag on which all or a part of the product code is recorded, a product on which the product code is marked, or a product information inquiry system or a POS system that supports disclosure of the resource information based on the product code.

As obvious as described above, the product code according to the present invention, that is, the source-marked URC (universal resource code) can realize product management per individual article and visibility of a supply chain. In other words, we can see not only the product inventory, but also the product development into its parts and raw materials or ingredients in the supply chain from downstream.

Realization of visibility in the supply chain is global procurement and waste elimination of resources, and a key concept of information logistics. The logistics means not just distribution of goods but “tracing back distribution of a product from the finished product to the inventory, manufacturing, manufactured parts, members and resources of the product.” In other words, it is a so-called “kanban” system (just-in-time system) in which all the products are computerized.

Visibility of the supply chain is, if it achieves an e-marketplace of part supply, a trigger for a change into more efficient and rational production and distribution of products around the world.

Unlike the hierarchy of items of a product (according to JAN code), URC shows how much or how many parts and raw materials are necessary for and have been actually used in processing and manufacturing a product as an individual article by indicating a supply chain of the individual article hierarchically (indicating a link of the individual article and its parts and raw materials).

MRP (Material Requirement Program) for a manufacturing technique is similar to the URC, but the URC further makes public and standardizes the product management according to the MRP.

When the URC database is transferred in the supply chain from the headstream, there occurs inconsistency between the databases on the way if a certain food company mislabels a production place in the chain. A certain section cannot alter the URC database on its own judgment.

The URC is usually managed as a MRP in manufacturing companies. The URC further makes public, standardizes and networks the product management according to the MRP.

It is Toyota's Just-in-time (JIT or Kanban) system, the 20th-century revolutionary mass production system, that indicates how many parts are required for sale of one “Crown” (a brand name of Toyota's major passenger car) by a kanban (an informative piece of paper) in the upstream process of the production line. Toyota has developed its own supply chain from sale of a vehicle at the most downstream of distribution up to the required parts under the closed “keiretsu” group organization including subcontractors. In the current car industry, this type of organization in the supply chain has now gone beyond the boundary of the manufacturer's group in an opener way. This is true not only in the car industry but also in the electronics industry and the consumer electronics industry. The MRP, which was performed in the closed group, has been developed into the open universal resource code according to the present invention.

Management of the URC of products all over the world leads to an ultimate solution of waste of resources. It is definite that the resource problem will be more serious if China with a population of 1 billion and India with that of 1.3 billion industrialize in addition of 1 billion people in the current member countries of OECD.

The infrastructure such as computers and networks for enabling to solve the resource problem technically has now been established. In spite of an obstacle of data standardization, high necessity shall overcome it. So, the use of URC had better go ahead.

The URC database with the final consumption as a starting point can achieve the transparent supply chain in the industries all over the world. This excites our spirit of romantic business expansion toward the 21^{st} century. This is the concept of visibility of the supply chain. The infrastructure of the universal resource management has been established. Only the sense of responsibility and leadership of the chain stores are lacking. Improvement, larger capacity, higher speed, standardization and disclosure of computer functions in 90 s have enabled sharing of database. In addition, broader band of communication will enhance the effectiveness and possibility of cross-use of the URC database. Meanwhile, there are a lot of social and economic roles the chain stores should play in the 21^{st} century in order to improve the current global distribution of products which blinds the sources of the products. The store that can disclose the product information indicating details of the product by scanning the two-dimensional code including the universal resource code marked on the product will be a differential store that is suitable for the information age and can create a true brand value based on the consumers' confidence.

Product development, which is a mission of a chain store, does not mean just determination of product specifications in consumers' shoes. Creating a mechanism for describing detail information of a product that the consumers want to know and disclosing it systematically and methodologically must be creating a new added value on the product.

As described above, the product code, the product marked with the product code, the product information inquiry system and the POS system according to the present invention enable it to disclose the attributes of the components of the product with the finished product as a starting point for final consumption and to make the source of the product visible. As a result, since the distribution system that discloses the source of the product is constructed, it becomes possible not only to optimize efficient and environment-friendly production, sales, use, service and recycling and to manage the global resources as a whole, but also to optimize management of the product through its life such as response to the quality required in the marketplace, extension of the product's life, easier part replacement and repair services, and easier recycling. The practical value of the present invention is extremely great in the today's information age.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram that shows a configuration of the entire POS system according to the first embodiment of the present invention.

FIG. 2A and FIG. 2B are diagrams that show database which are held in a database unit included in a main frame of the system 1.

FIG. 3 is a diagram that shows a structure of a product code used for the system 1.

FIG. 4 is a diagram that shows a sample of the POS system 1.

FIG. 5 is a flowchart that shows processing procedure corresponding to two types of product codes according to the POS system 1.

FIG. 6 is a diagram for describing an application that makes it possible to check whether the source of the meat is true or not using the POS system 1.

FIG. 7 is a communication sequence that shows processing procedure in the application as shown in FIG. 6.

FIG. 8 is an external view of an allergy determination device applying the product code according to the present invention.

FIG. 9 is a flowchart that shows processing procedure of the allergy determination device.

FIG. 10A and FIG. 10B are diagrams that show samples of display screens of the allergy determination device.

FIG. 11 is a diagram that shows a sample of the product code used for the POS system in the second embodiment of the present invention.

FIG. 12 is a block diagram that shows a configuration of the POS system according to the second embodiment.

FIG. 13 is a diagram that shows a receipt printed out by the POS terminal constituting the system 2.

FIG. 14 is a diagram that shows a member card for a customer used in the system 2.

FIG. 15 is a system configuration diagram that shows relationship between a plurality of manufacturers, a plurality of sales companies, and a service company that mediates between them in the system 2.

FIG. 16 is a diagram that shows a sample of classification data structure file that held by the information service Web system of the service company in the system 2.

FIG. 17 is a diagram that shows a sample of product data generated by the production management system of the manufacturer in the system 2.

FIG. 18 is a system configuration diagram that shows relationship between a customer, a sales company, and a service company that mediates between them in the system 2.

FIG. 19 is a diagram that shows a search result screen image on a PC of the customer in the system 2.

FIG. 20 is a system configuration diagram that shows relationship between a PC (a Web browser) used by a manufacturer, sales company, and a service company that mediates between them in the system 2.

FIG. 21 is a diagram that shows a search result screen image on a PC of the manufacturer in the system 2.

FIG. 22 is a diagram that shows a conventional product code (a JAN code).

### DESCRIPTION OF THE PREFERRED EMBODIMENT(S)

The following is an explanation of the embodiments of the present invention with reference to figures.

(The First Embodiment)

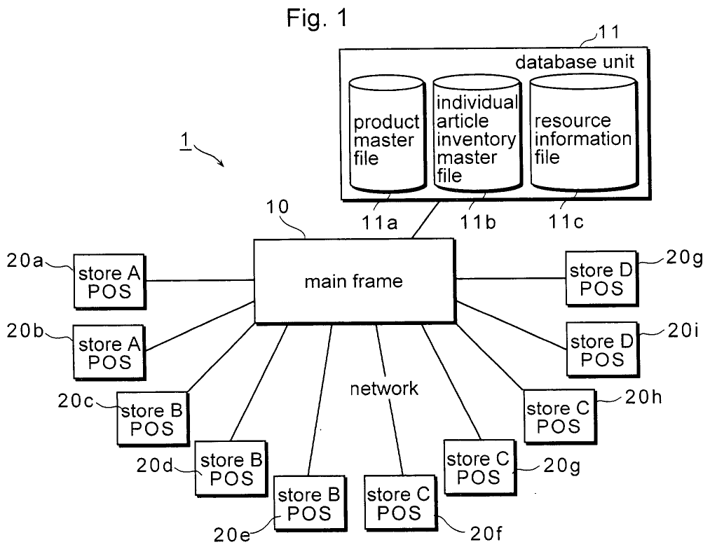

FIG. 1 is a diagram that shows a configuration of the entire POS system 1 of the first embodiment that is the product information inquiry system according to the present invention. This POS system 1 is a network-centric-type POS system, and includes a main frame 10 that is a management device for managing, as a whole, inventory of products of all the stores in real time and POS terminals 20a˜20j that are connected to the main frame 10 via a communication network and placed on each store.

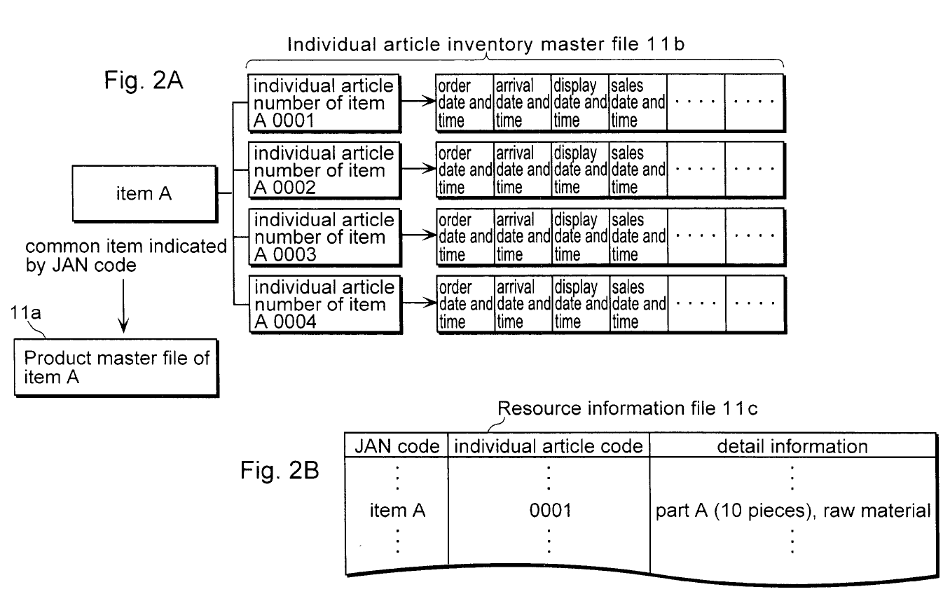

The main frame 10 includes a database unit 11 that stores a product master file 11a on which product description information such as product names and prices are recorded per product code marked on each product, an individual article inventory master file 11b on which storing/retrieving information, etc. per individual article is recorded, a resource information file 11c that is a collection of detail information corresponding to the product codes marked on the products, etc., as shown in FIGS. 2A and 2B. The main frame 10, upon receiving the processing results in POS terminals 20a˜20j, perform real-time inventory management per individual article by reflecting the results to the product master file 11a and the individual article inventory master file 11b in real time, or sends back the applicable detail information by searching the resource information file 11c in response to the inquiry of the product code from the POS terminals 20a˜20j.

The POS terminals 20a˜20j include bar code readers that read out electronically the product codes marked on the products, tow-dimensional code readers, display devices, communication interfaces, and so on.

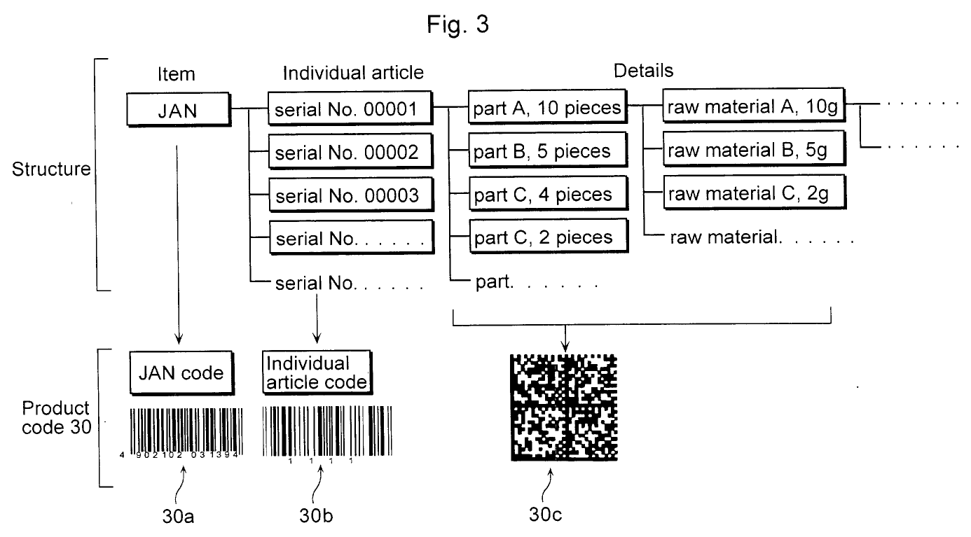

FIG. 3 is a diagram that shows a structure of a product code used for the POS system 1. A product code 30 is a unified code that is source-marked at a stage of manufacturing, shipping or wholesaling a product, and includes an item code 30a, an individual article code 30b and a detail code 30c.

The item code 30a is a bar code such as a JAN code, for example, that specifies an item to which the product belongs. The individual article code 30b is a lot number or a serial number marked on the product at manufacturing it, for example, that can identifies the product uniquely in the world, independently of the sales store or the manufacturer of the product. The detail code 30c is a code that indicates detail information of the product including information of the product itself, and the sources of the components, raw materials and ingredients. It is a two-dimensional code, for example, describing parts and raw materials, a raising place and feed and chemicals used in the raising process of livestock or a farm-raised animal or fish, or chemical fertilizers, pesticides and process methods of ingredients of a food product, as detail product information for MRP.

This product code 30 is printed on a label of paper or the like and marked on a product, or a part or all of the product code 30 is marked on a product under a condition of being stored in an RFID (Radio Frequency Identification) chip (a non-contact IC tag). For example, the item code 30a and the individual article code 30b are printed on a recording medium instead as a label and marked on the product, and the detail code 30c is stored on an RFID chip as a recording medium and marked on the product.

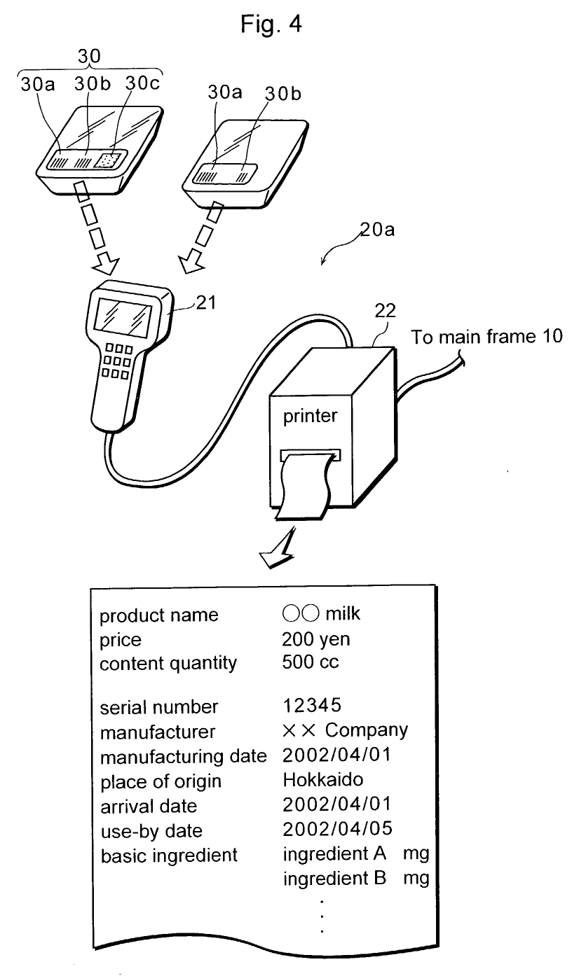

FIG. 4 is a diagram that shows a sample of POS terminals 20a ˜20j in the POS system 1. This POS terminal 20a includes a handy terminal 21 that scans off the product code 30 marked on the product optically or via a radio communication, and a printer 22 that prints out onto paper such as a receipt according to the instruction of the handy terminal 21.

The handy terminal 21 has a function of scanning off two types of product codes. That is, for either the product to which the first type product code 30 (the item code 30a, the individual article code 30b and the detail code 30c) as shown in FIG. 3, or the product to which the second type product code 30 (the item code 30a and the individual article code 30b only), the handy terminal 21 has a function of acquiring detail information of the product and having the printer 22 print it.

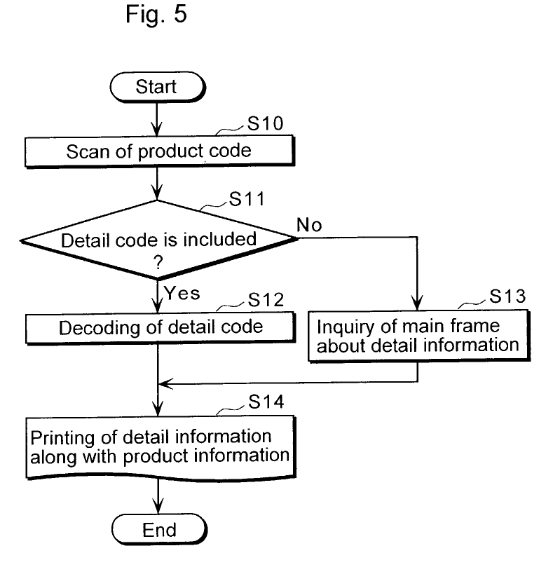

FIG. 5 is a flowchart that shows processing procedure of the handy terminal 21 for two types of product codes. The handy terminal 21 scans off the product code marked on the product according to the instruction of an operator (Step S10), judges whether the detail code 30c is included in the scanned product code or not (Step S11), and when it is included (“Yes” in step S11), generates the detail information by decoding the scanned detail code 30c (Step S12). On the other hand, when the detail code 30c is not included in the scanned product code (“No” in Step S11), the handy terminal 21 acquires the detail information of the product from the resource information file 11c of the main frame 10 by sending the scanned item code 30a and the individual article code 30b to the main frame 10 to inquire of it (Step S13), and transfers the acquired detail information to the printer 22 to have it output on a receipt or the like (Step S14).

In this manner, the operator can obtain detail information of the product (such as an item, serial number, a manufacturing lot number, a manufacturer, a manufacturing date, quantity/weight, a use-by-date, an arrival date, a producer, a country (or place) of origin, types and quantity/weight of parts and raw materials or ingredients). Therefore, consumers can check the source of the product at the store before selecting the product to buy.

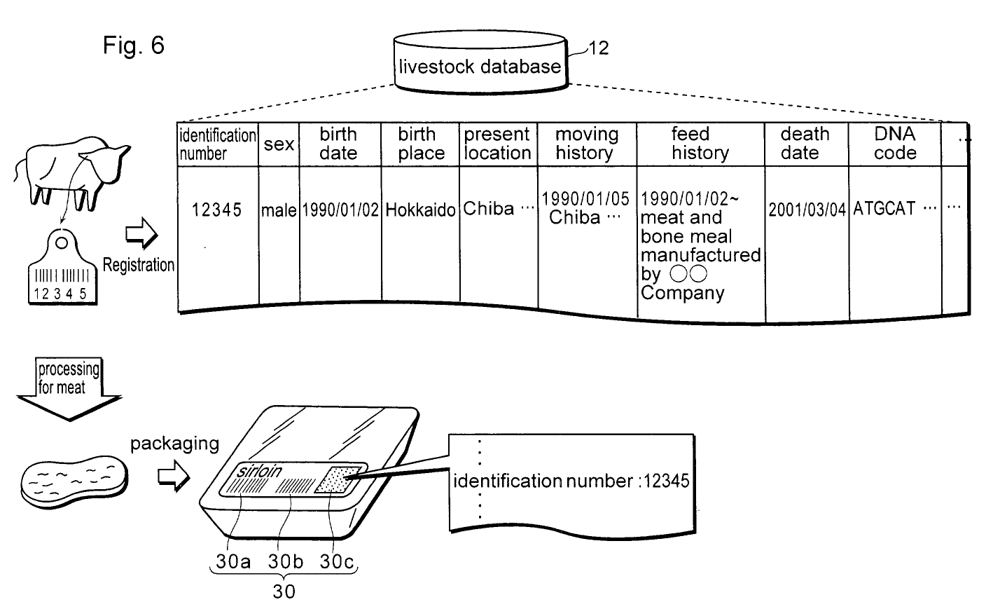

FIG. 6 is a diagram that shows an application of the POS system 1. Here, an example is shown for enabling the check of the source of the product or the check of whether the description of the product (correspondence between the product itself and the product code 30) is true or not by including an identification number for specifying the livestock as the source of the meat in the detail code 30c of the product code 30 marked on the product.

More specifically, livestock database 12 in which information of livestock across the country is registered is provided in the database unit 11 of the main frame 10. An identification number is assigned to each livestock at its birth for identifying it uniquely, and the “identification number” and attributes as shown in this figure are registered in the database unit 11. That is, the “sex”, “birth date”, “birth place”, “present location”, “DNA code” and others of the livestock are registered at its birth, the feed which has been given to the livestock is registered as a “feed history”, the moving of the livestock is registered as a “moving history”, and the death of the livestock is registered as a “death date”.

And, when the livestock is processed for meat, the identification number of the livestock is accompanied to the meat obtained by the processing. Specifically, when it is sold as meat, the identification number of the livestock before the processing is incorporated in the detail code 30c of the product code 30.

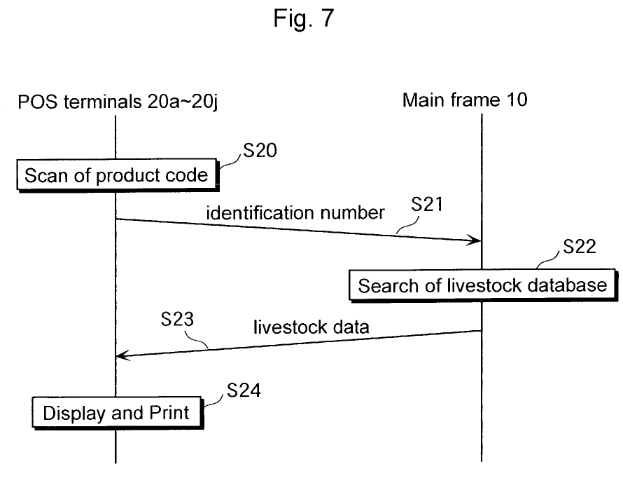

Furthermore, the handy terminal 21 of the POS 20a placed on the store has a function of referring to the livestock database 12 of the main frame 10 with the identification number of the livestock as a key. More specifically, as shown in the communication sequence of FIG. 7, the handy terminal 21 scans the product code 30 marked on the product (Step S20), and sends the identification number included in the product code 30 to the main frame 10 to inquire the source (Step S21). The main frame 10 searches the livestock database 12 with the identification number notified by the handy terminal 21 as a key (Step S22), and sends back the information of the corresponding record to the handy terminal 21 (Step S23). Upon receiving the information, the handy terminal 21 outputs it to the display unit or the printer 22 (Step S24).

Accordingly, a consumer can scan the product code 30 marked on the meat put on sale with the handy terminal 21 to inquire of the main frame 10, and thereby, obtain the information about the source of the meat easily. Also, since the obtained information includes the DNA code of the livestock before processing, it is also possible to check whether the description of the product is true or not (whether the product corresponds to the product code 30 or not) by collating that DNA code with the DNA code obtained by the actual inspection of the product.

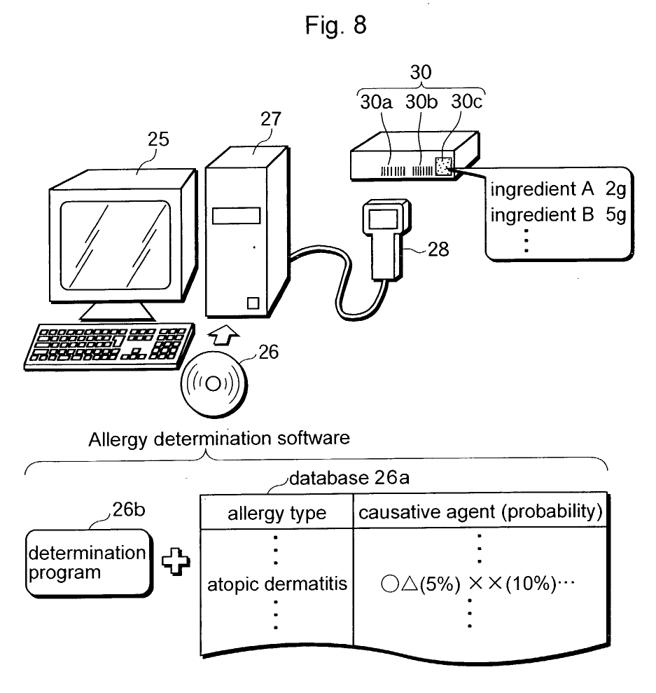

FIG. 8 is an external view of an allergy determination device 25 applying the product code 30 according to the present invention. This allergy determination device 25 provides information about a possibility of causing an operator who eats food to develop an allergic symptom based on the information entered by the operator about his allergic constitution and the information included in the product code 30 marked on the product (food) about the basic ingredients included in the food. The allergy determination device includes a computer device (PC) 27 with dedicated software (allergy determination software) 26 being installed, and a code reader 28 for scanning off the product code 30.

The allergy determination software 26 includes a database 26a that is information about allergic types and corresponding causative agents (including a probability (%) of causing allergy), and a determination program 26b for determining a level of allergy based on the database 26a.

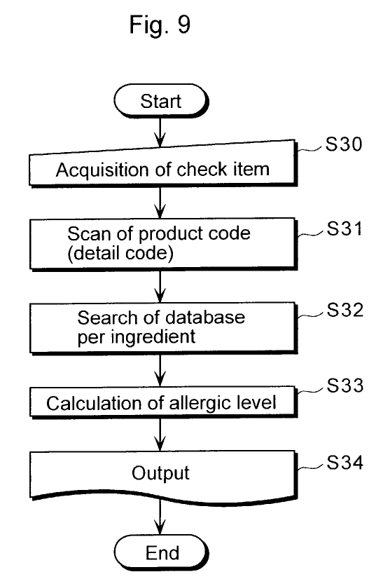

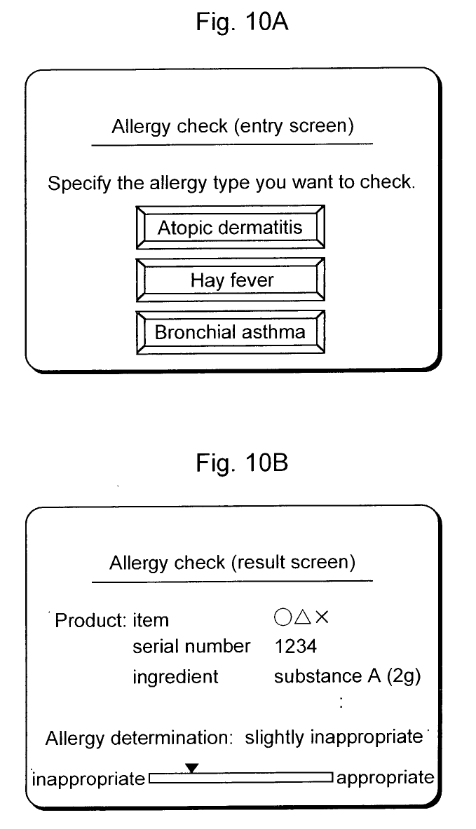

FIG. 9 is a flowchart that shows processing procedure of the PC 27 based on the allergy determination software 26. First, the PC 27 displays “Allergy Check (entry screen)” as shown in FIG. 10A, acquires the allergic constitution to be checked specified by an operator (Step S30), and then, scans off the product code 30 marked on the product by the operator's operation using the code reader 28 (Step S31).

Next, the PC 27 refers to the database 26a, determines whether all the ingredients described in the scanned detail code 30c of the product code 30 correspond to the causative agents of allergy specified by the operator, and when they correspond, reads out the probabilities (Step S32). After the PC 27 completes the search of all the ingredients, it sums up all the probabilities read out from the database 26a (Step S33), and displays the total value on a screen as the allergy determination result, as shown in FIG. 10B, or outputs it by voice (Step S34). The allergy determination result is displayed in stages in an analog fashion: when the total of the probabilities of causative agents is 0%, for instance, “appropriate” is displayed, and when the total is 100%, “inappropriate” is displayed.

Accordingly, the operator can learn whether the product (food) on sale suits his constitution or not by an easy operation at the store, and therefore obtain useful information for selecting products.

This allergy determination device 25 is not limited to a stationary device, but may be any kind of computer to which the allergy determination software 26 can be installed, and it can also be realized by a portable device like a handy terminal.

Also, the allergy determination device 25 can also be realized as a side effect determination device that determines whether a medicine causes a side effect or not, if the relationship between the allergy constitution and the causative agent is substituted by that between the constitution susceptible to a side effect caused by a medicine and the causative agent.

As described above, the product code 30 according to the present invention includes the detail code 30c indicating the detail information of the product, and the resource information of the product itself and its parts and raw materials (ingredients) can be incorporated in this detail code 30c. Therefore, an open information service system can be realized that can not only perform lean resource management and real-time inventory management but also provide various information about products for consumers.

An application system using the detail code 30c is not limited to the above system, but it can be realized as the following system.

For example, when a product is an electric appliance or the like comprising a lot of parts, the product code 30 according to the present invention can be used for services such as maintenance and repair of the appliance. More specifically, a manufacturer code, an item code, a serial number, etc. are described in the detail code 30c for all the parts comprised in the product in advance. When the product breaks down, a consumer scans off the product code 30 of the product and sends it to the manufacturer. The manufacturer can search and obtain the necessary replacement parts by accessing the database of repair parts including the second source based on the parts information included in the product code 30. Therefore, quick repair becomes possible.

Likewise, when the manufacturer receives the product code 30 from the consumer, it can take an action for a product liability problem such as a quick offer of quality-related information including component parts by searching the quality support database based on the product code 30.

Also, when sale of a product is prohibited due to a recall, etc., the prohibited product can be found and any action can be taken quickly when the product code 30 is scanned at the POS terminal 20a by storing a flag (a flag indicating prohibition of sale) corresponding to the product code 30 in the data storage unit of the main frame 10 or the POS terminal 20a.

Also, information about environmental load or toxicity of component parts of the product is incorporated in the detail code 30c of the product code 30, and a Web site is set up on the Internet for disclosing information about methods of scrapping and disposing toxic elements or those which apply load on environment. Therefore, if a consumer scans the product code 30 at the store or a recycling manufacturer scans it on the site, specifies the environmental load or toxicity of the component parts of the product, and then, accesses the Web site, he can learn the method of scrapping and disposing the product. Thereby, protection of the earth and recycling of earth resources can be promoted.

Also, a Web site of a collection of quality information (information about defects) corresponding to the product or the parts can be set up on the Internet so as to disclose the information. If a user accesses the Web site and notifies of the product code 30, he can obtain the quality information about the parts described in the detail code 30c of the product code 30.

Furthermore, as for a product such as frozen goods, a recommended storage temperature may be recorded in the detail code 30c, or the temperature may be detected by an antenna of an RFID that is a recording medium of the detail code 30c. More specifically, a dielectric material having high temperature dependence is inserted between electrodes of a condenser on an LC circuit constituting the antenna of the RFID. Then, since the resonance frequency of the RFID depends upon the ambient temperature, the code reader can read out the recommended storage temperature from the memory of the RFID marked on the product and measure the actual temperature of the product based on the resonance frequency of the RFID (or the frequency drift amount). As a result, it can be traced whether the product is stored at a proper temperature or not by comparing the recommended storage temperature and the actual one. For example, when the measured temperature exceeds the recommended storage temperature, a warning to the effect is given so as to help manage freshness of the product.

Note that there are two types of data formats for the information to be recorded in the detail code 30c, in the case of recording a text itself and in the case of recording a coded one. When the coded text is recorded in the detail code 30c, a reference table or a conversion table indicating the relationship between the coded information and the original one may be placed in the POS terminals 20a˜20j and/or the main frame 10.

(The Second Embodiment)

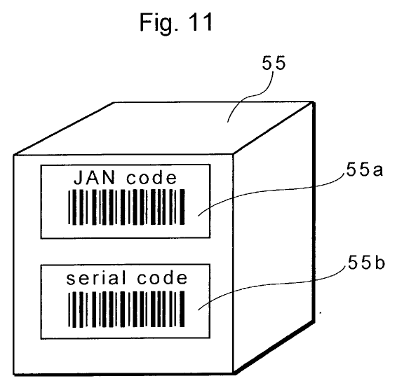

Next, the POS system according to the second embodiment of the present invention will be explained below. Unlike the POS system 1 of the first embodiment that manages the resources of the product on which the product code is marked, including three codes, the item code, the individual article code and the detail code, the POS system of the second embodiment can manage resources of a product 55 on which two codes, that is, the item code (a JAN code 55a) and the individual article code (a serial code 55b), are source-marked, as shown in FIG. 11. Note that the serial code 55b is not a code determined by the sales store of the product on its own judgment, but a code indicating a serial number, etc. which the manufacturer has given to the product uniformly (under a certain rule set down so that the serial number does not overlap the other manufacturer's serial number).

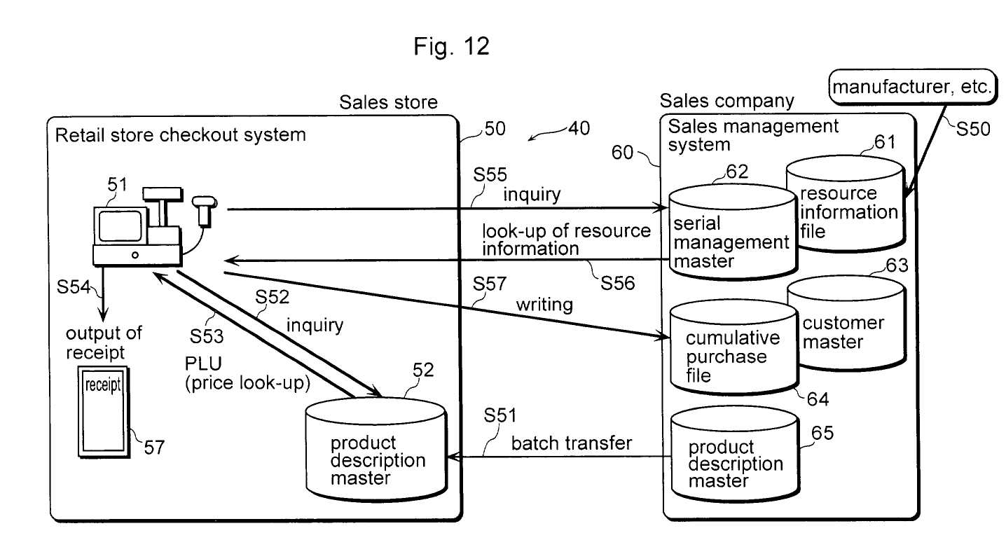

FIG. 12 is a block diagram that shows a configuration of the POS system in one sales company among a POS system 40 according to the present embodiment. The POS system 40 is an ERP (Enterprise Resource Planning) system that can release resource information of a product to consumers, and it includes a sales management system 60 and a plurality of retail store checkout systems 50 which are connected to the sales management system 60 via a communication network.

The retail store checkout system 50 is a so-called POR (Point of Resource) checkout system including a plurality of POS terminals 51 located in the store and a store controller or the like that holds a product description master 52. The POS terminal 51 is a POS cash register including an entry key, a bar code reader, a printer for printing a receipt, etc. The POS terminal 51 has a function of outputting inquiry results of product information per individual article on a receipt, in addition to the functions of the general POS cash register.

The sales management system 60 is a computer system that holds database such as a resource information file 61 in which resource information (such as a production place and a producer) for each product is registered, a serial management master 62 in which combinations of the manufacturer codes (the third˜the seventh digits of the JAN code 55a) marked on the product and the serial codes 55b are registered, a customer master 63 in which a customers' names and their addresses, etc. are registered, a cumulative purchase file 64 that stores cumulative purchase history per customer, and a product description master 65 in which product names and their prices corresponding to combinations of the manufacturer codes (the third˜the seventh digits of the JAN code 55a) and the serial codes 55b are registered. Processing of the POS system configured as above is as follows.

First, processing of updating the product description master 52 at the store is similar to that of the general POS checkout system. The product description master 52 is updated by receiving the description information such as the product prices and names from the product description master 65 of the sales management system 60 by a batch transfer once a day (Step S51).

On the other hand, sales processing is performed in a different flow from that of the general POS checkout system. In the general POS checkout system, the POS terminal 51 scans the JAN code 55a, inquires of the product description master 52 (Step S52), looks up the product name and the price, etc. (Step S53), and outputs them on a receipt (Step S54). The retail store checkout system 50 according to the present embodiment is different in the processing procedure, which will be explained below.

First, the sales management system 60 has received the resource information of a due-in product in the resource information file 61 at the shipment from the manufacturer (Step S50).

When the product is sold, the POS terminal 51 scans the JAN code 55a first, and then scans the serial code 55b.

Then, the POS terminal 51 inquires of the product description master 52 using the scanned JAN code 55a (Step S52), and looks up the product name and the price, etc.

At the same time, the POS terminal 51 inquires of the serial management master 62 and the resource information file 61 of the sales management system 60 using the manufacturer code included in the scanned JAN code 55a and the serial code 55b (Step S55), so as to look up the resource information (Step S56).

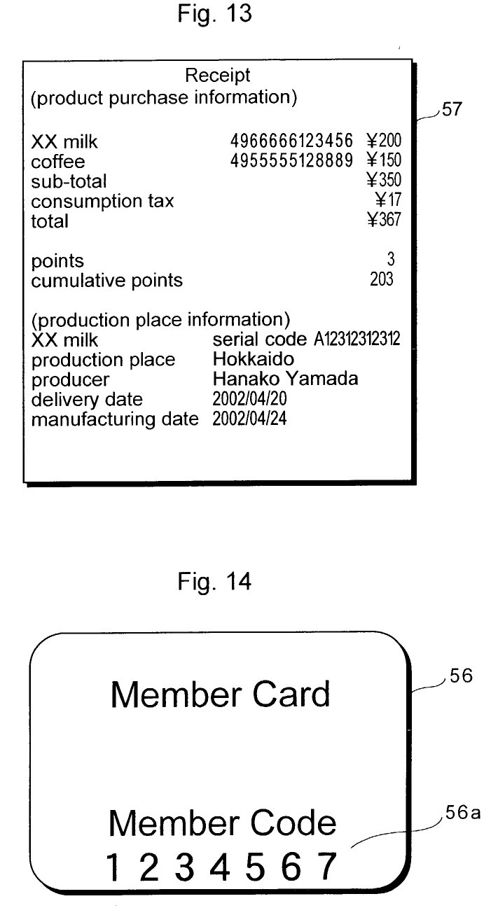

The POS terminal 51 outputs the product name and the price, etc. obtained from the product description master 52 and the resource information obtained from the sales management system 60 on a receipt (Step S54). An output sample is shown in FIG. 13.

When a customer presents the member card 56 as shown in FIG. 14, the information of the member card 56 is inputted. The POS terminal 51 writes that information together with the resource information in the cumulative purchase file 64, and writes the point information in the customer master 63.

In this manner, the consumer who purchased the product can see the receipt and check the resource of the product (such as the production place and the producer) at the store. Also, since the resource information is accumulated in the cumulative purchase file 64, a customer who purchased a product of a certain resource can be easily searched and found out even after a lapse of years.

Also, according to the present system, an individual article can be managed using a combination of the manufacturer code included in the JAN code 55a and individual product is managed, it becomes possible to adjust inventory accurately by judging the actual commercial value of the inventory product, or grasp the situation or distribution process of individual product by recording and accumulating an event such as a flag and a manager of the product, etc. on every stage of the distribution which the product has passed.

The following function may be provided as a measure for a breakdown of each computer device, communication network, etc. included in this system. For example, when the retail store checkout system 50 cannot communicate with the sales management system 60, the POS terminal device 51 temporarily performs the same local processing as the ordinary POS terminal does. As soon as the communication function recovers, the POS terminal device 51 performs recovery processing of performing processing of looking up a resource of a product which has not yet been processed and reporting the result to the purchaser via an e-mail, etc. after the processing. For example, in the case of an incommunicable situation, the POS terminal device 51 performs checkout processing without resource information of a product, and accumulates the information (such as the product code) of the processed product. And when the communication recovers, the POS terminal device 51 delivers the accumulated product code to the sales management system 60. The sales management system 60 may read out the resource information, and send it to the customer via e-mail.

Next, preliminary processing for providing information to a customer and a manufacturer (information collection) in the POS system 40 will be explained.

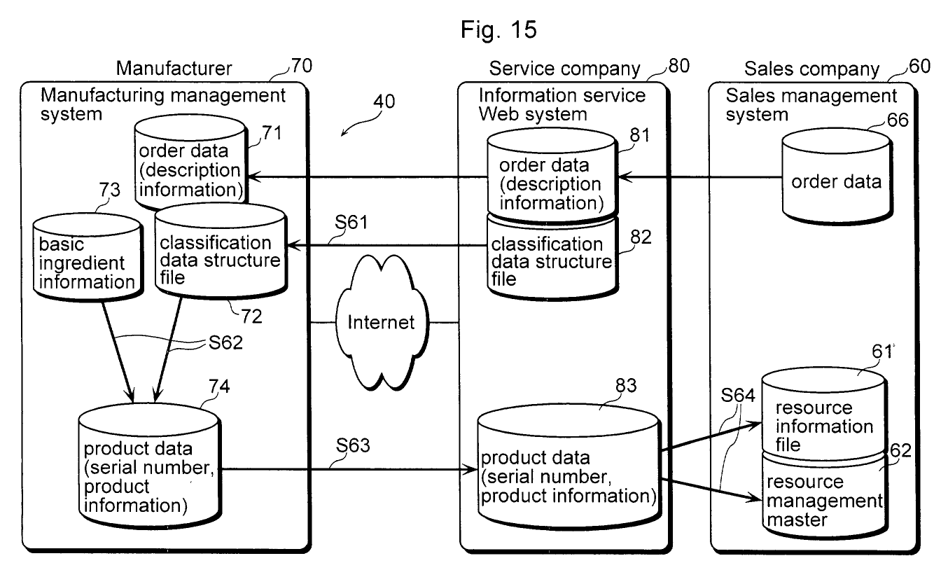

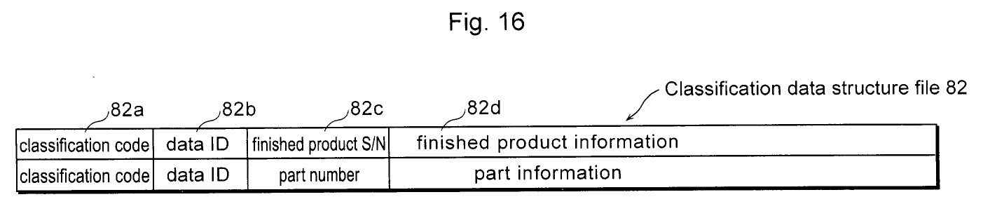

FIG. 15 is a system configuration diagram that shows relationship between a plurality of manufacturers, a plurality of sales companies, and a service company that mediates between them in the POS system 40 according to the present embodiment. As shown in this figure, the POS system 40 further includes, in addition to the components as shown in FIG. 12, a manufacturing management system 70 run by a manufacturer and an information service Web system 80 run by a service company that provides resource information to consumers independent of the manufacturer and sales company. Note that the sales management system 60 of the sales company holds order data 66 in which information for ordering a product from a manufacturer is stored.

The information service Web system 80 of the service company is a server computer that relays the order data 66 from the sales company to the manufacturer and has a Web site for providing the resource information of the product to the sales company. It holds a classification data structure file 82 that is data specifying data structure per classification of products. The classification data structure file 82 includes a classification code 82a for specifying a product item, a data ID 82b for identifying a data structure, number information 82c for storing a number of a product (a serial number or a part number of a finished product), and detail information 82d for storing details of a finished product or parts including resource information such as a production place, raw materials, etc.

The manufacturing management system 70 of the manufacturer is a computer system that, upon receiving order data and classification data structure file from the information service Web system 80 of the service company via the Internet, provides the detail information including the resource information about the product to be shipped and delivered as the product data based on these information. It holds basic ingredient information 73 that is database of parts and basic ingredients or raw materials obtained in the MRP system or the like, etc.

Processing of the POS system 40 as configured as above is as follows.

First, the manufacturing management system 70 of the manufacturer receives the classification data structure file from the information service Web system 80 of the service company (Step S61), or receives the classification data structure file as well as the order data.

Then, the manufacturing management system 70 of the manufacturer acquires, at the stage for shipping the ordered product, the information defined by the classification data structure file which has been received from the information service Web system 80 of the service company, from the basic ingredient information 73 held in the MRP system, and prepares the product data 74 (step S62).

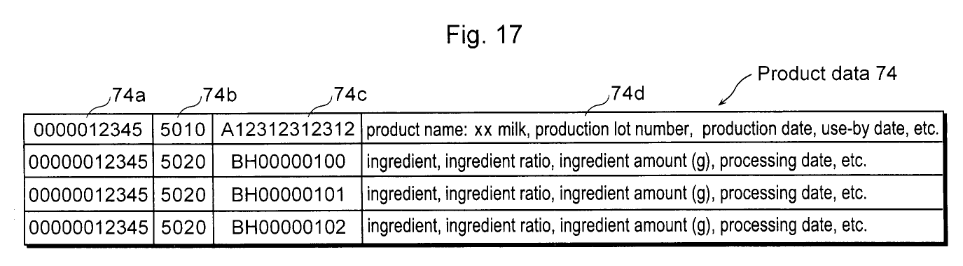

FIG. 17 shows a sample of the generated product data 74, a sample of milk (classification: 0000012345) in this case. This product data 74 has a data structure corresponding to the classification data structure file sent from the information service Web system 80. An item of a product to be shipped is stored in a classification code 74a, a code for identifying the data structure (an data ID 82b specified by the classification data structure file) is stored in a data ID 74b, a serial number of a finished product or a part number of a part to be shipped is stored in a number information 74c, and detail information of the finished product or the part is stored in detail information 74d.

After completing generation of this product data 74, the manufacturing management system 70 of the manufacturer uploads it to the information service Web system 80 (Step S63). The uploaded product data 83 is downloaded to the sales management system 60 of the sales company (Step 564), registered in the resource information file 61 and the serial management master 62, and used in the retail store checkout system 50 of the sales store, as shown in FIG. 12.

Accordingly, only if the sales company sends the order data to the service company through the mediation of the information service Web system 80 of the service company, it can obtain the product as well as acquire the data indicating the details such as the resources of the product so as to help disclose information to consumers. Meanwhile, only if the manufacturer prepares the product data according to the classification data structure file from the service company and uploads it, it can contribute to information disclosure to consumers.

Next, an aspect of information service to consumers in the POS system 40 will be explained below.

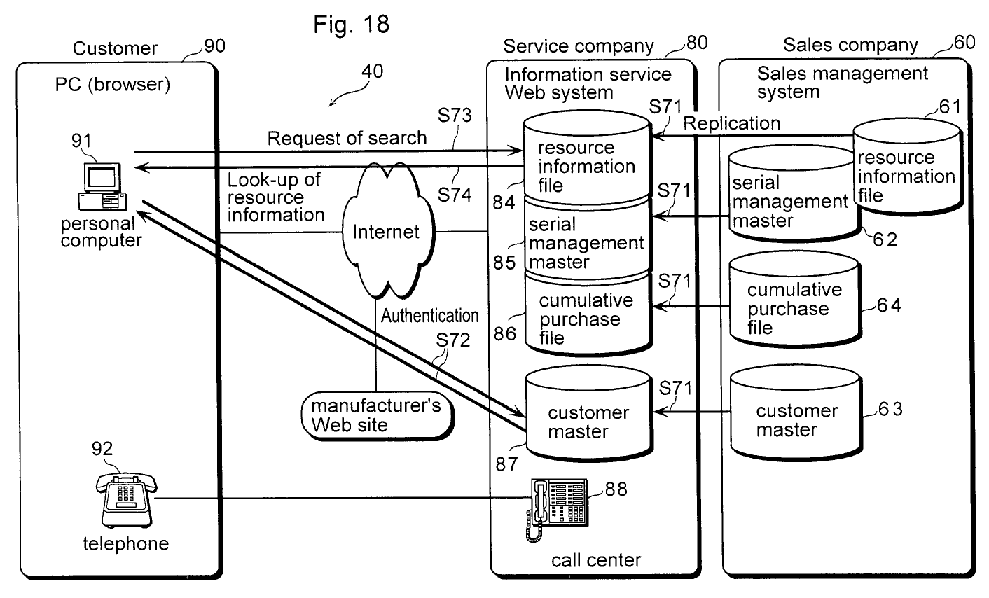

FIG. 18 is a system configuration diagram that shows relationship between a customer, a sales company and a service company that mediates between them in the POS system 40 according to the present embodiment. As shown in this figure, this POS system 40 is an information service system that enables a customer to search for resource information of a product and view it. The POS system 40 further includes a PC (browser) 90 used by the customer in his home, in addition to the components as shown in FIG. 12 and FIG. 15.

Processing of the POS system 40 as configured as above (a search of resource information by a customer) is as follows.

First, the sales management system 60 of the sales company replicates the resource information file 61, the serial management master 62, the customer master 63 and the cumulative purchase file 64 into the information service Web system 80 (Step S71).

The customer accesses the information service Web system 80 using a Web browser installed into a PC 91, enters his member code 56a engraved on the member card 56, and obtains authentication of the member (Step S72). If the customer cannot obtain the authentication, he cannot go on to the following steps, nor view the resource information of the product.

Next, the customer visually reads the JAN code 55a and the serial code 55b marked on the product he purchased, enters them in a search screen displayed on the PC 91 using a key board, etc., and clicks a search button, etc., so as to request the search (Step S73).

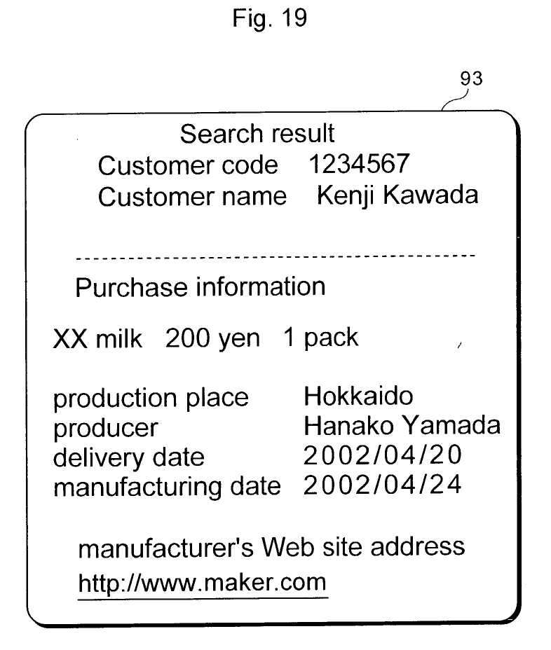

The information service Web system 80 of the service company searches the cumulative purchase file 86, the serial management master 85 and the resource information file 84 based on the member code entered by the customer and a combination of the manufacturer code (the third˜the seventh digits) and the serial code 55b included in the JAN code 55a, and sends the applicable product name, price, resource information, etc. back to the PC 91 of the customer (Step S74). The PC 91 of the customer outputs to display the looked-up product name, price and resource information on the Web screen of the browser, as shown in the search result screen image 93 of FIG. 19. Note that since the resource information includes a URL of the manufacturer's Web site, a link to the URL is displayed.

As described above, according to the POS system 40, the database such as the resource information file 61 held by each of a plurality of sales companies are collected in the information service Web system 80 of the service company. The customer can look up not only the name and price of the product he purchased but also the detail resource information such as the production place, the producer and basic ingredients or raw materials, wherever he purchases the product. When the customer wants further detail information, he can access the manufacturer of the product only if he clicks a link to the Web site of the manufacturer displayed on the screen of the PC 91.

When a call center 88 is opened using this information service Web system 80, it is possible to give an alarm by e-mail or a letter if there occurs an inquiry by a telephone 92 or an e-mail or a quality problem.

Furthermore, if not only the resource information such as a production place but also information about a repair history of a used car, information about parts constituting a car, an electric appliance, etc., information about ingredients of a medicine, information about building materials, information about a food additive and its amount, or information about materials of a health food is stored in the resource information file 61, a customer can obtain the information of the product he purchased easily and quickly when there occurs a problem such as a recall of a new car, a drug injury, and a food additive.

As a countermeasure to a manufacturer's false registration, for example, as a countermeasure to the case where the manufacturing management system 70 of the manufacturer prepares the false product data 74 and uploads it to the information service Web system 80, in the POS system 40 as shown in FIG. 15, a public message board joined by companies involving a supply chain may be provided on the cumulative purchase file 86 of the information service Web system 80. The public message board carries (1) opinions about products purchased by customers, (2) opinions (responses) of manufacturers, and (3) opinions (responses) of distributors, for instance. Thereby, appropriate management by mutual monitoring (a state of tension) can be secured. That is, proactive life cycle management of resources can be realized.

Next, an aspect of information service to a manufacturer in the POS system 40 will be explained.

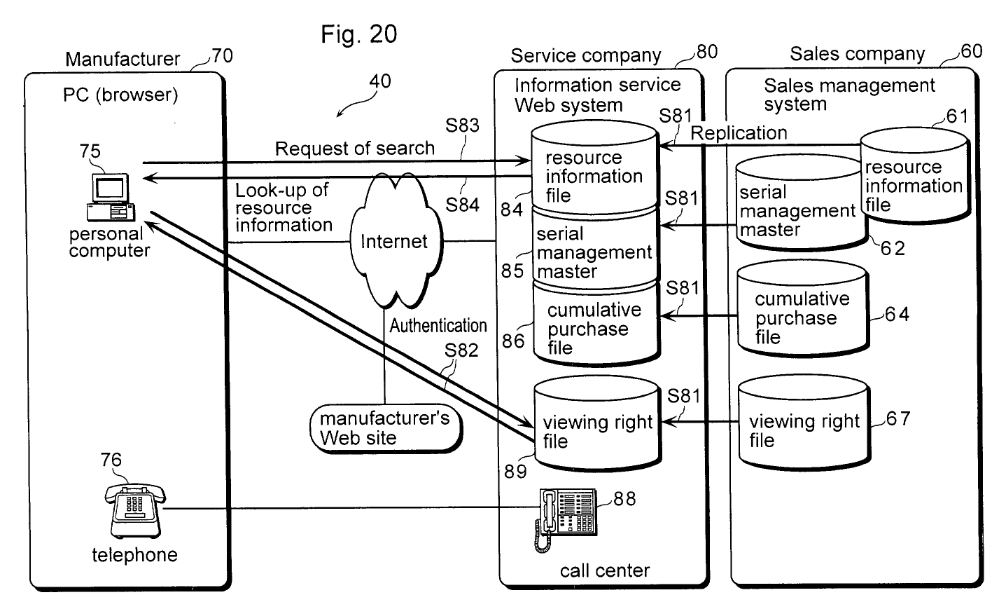

FIG. 20 is a system configuration diagram that shows relationship between a PC (a Web browser) used by a manufacturer, a sales company, and a service company that mediates between them in the POS system 40 according to the present embodiment. As shown in this figure, this POS system 40 is an information service system that enables a manufacturer to search and view information about a customer who purchased its product and retail sales. The POS system 40 further includes a PC (a Web browser) 75 used by a manufacturer, in addition to the components as shown in FIGS. 12, 15 and 18.

The sales management system 60 of the sales company holds a viewing right file 89 in which conditions for disclosing customer information and retail information (viewing conditions) in response to a viewing request from a manufacturer are registered.

Processing of the POS system 40 as configured as above (a search for a manufacturer's customer information) is as follows.

First, as in the case of the POS system 40 shown in FIG. 18, the sales management system 60 of the sales company replicates the resource information file 61, the serial management master 62, the cumulative purchase file 64 and the viewing right file 67 into the information service Web system 80 (Step S81).

An operator of a manufacturer accesses the information service Web system 80 using the Web browser installed into the PC 75, enters the manufacturer code and the password, sends them to the viewing right file 89, and acquires a viewing condition from the viewing right file 89 (Step S82).

Next, the operator of the manufacturer enters the JAN code 55a marked on its own product and clicks a search button, etc., so as to request the search.

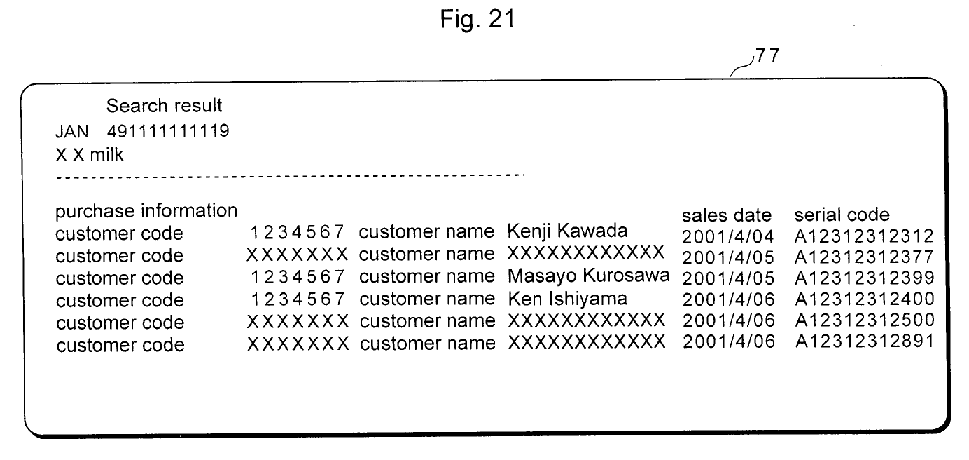

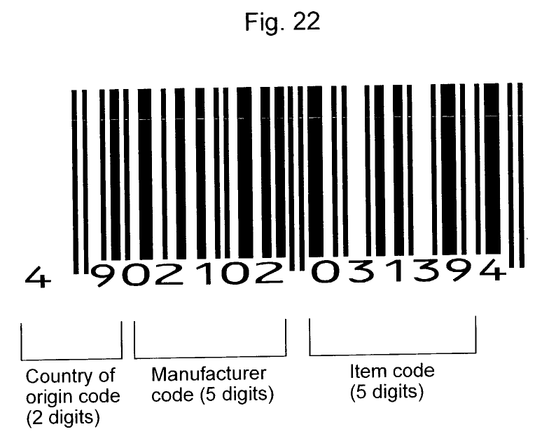

The information service Web system 80 of the service company searches the cumulative purchase file 86, the serial management master 85 and the resource information file 84 among the JAN code 55a sent from the PC 75, reads out a customer code (member code) of a customer who purchased the product, the customer name, the sales date and the serial code of the product, and sends them back to the PC 75 of the manufacturer (Step S84). The PC 75 of the manufacturer outputs and displays the looked-up customer code, customer name, sales date, serial code, etc. on a Web screen of the browser, as shown in a search result screen image 77 of FIG. 21.

As described above, according to the POS system 40, the database such as the cumulative purchase file 64 held by each of a plurality of sales companies is collected in the information service Web system 80 of the service company. Therefore, if only the manufacturer accesses the information service Web system 80, it can look up the customer and sales information of its own product such as a customer and a purchase date.

When a call center 88 using this information service Web system 80 is opened, it is possible to give an alarm by e-mail or a letter if there occurs an inquiry by a telephone 92 or e-mail or a quality problem, as in the case of the POS system 40 shown in FIG. 18.

What is claimed is:

1. A product that is source-marked with a product code,
wherein the product code includes:
an item code for specifying an item of the product; and
an individual article code for identifying the product uniquely among a group of products belonging to the same item.

2. The product according to claim 1,
wherein the product code further includes a detail code for specifying details of the product.

3. The product according to claim 2,
wherein the detail code indicates a constituent element of the product.

4. The product according to claim 3,
wherein the detail code indicates at least one of a production place of the product, and feed and a chemical used in a raising process of the product when the product is livestock meat or cultivated fish or seafood, and indicates at least one of a processing method of the product, and a chemical fertilizer and a pesticide used for an ingredient of the product when the product is food.

5. The product according to claim 4,
wherein the detail code is a two-dimensional code.

6. The product according to claim 4,
wherein the detail code is stored in a memory of an RFID chip.

7. A product information inquiry system for supporting inquiry of information about a product, the system including a terminal device and a management device which are connected via a communication channel,
wherein the product is source-marked with a product code including:
an item code for specifying an item of the product; and
an individual article code for identifying the product uniquely among a group of products belonging to the same item,
the terminal device includes:
a read-out unit operable to read out the product code marked on the product;
a sending unit operable to send the read-out product code to the management device;
a receiving unit operable to receive product information sent from the management device; and
an output unit operable to output for displaying or printing the received product information, and
the management device includes:
a product information memory unit operable to memorize at least one of an item code, an individual article code and a detail code along with the corresponding product information indicating what at least one of the item code, the individual article code and the detail code means and manages; and
a return unit operable to read out the corresponding product information from the product information memory unit and send the product information back to the terminal device when at least one of the item code, the individual article code and the detail code is sent from the terminal device.

8. The product information inquiry system according to claim 7,
wherein the product code includes individual identification information for specifying a living thing before processing for food when the product is food obtained by processing one living thing,
the product information memory unit memorizes DNA information of the living thing before processing as the product information along with the corresponding individual identification information for specifying the living thing, and
the return unit reads out the corresponding DNA information from the product information memory unit and sends the DNA information back to the terminal device when the product code is sent from the terminal device.

9. The product information inquiry system according to claim 7,
wherein the terminal device further includes a judgment unit operable to judge whether the origin or the description of the product is true or not based on the DNA information sent from the management device.

10. The product information inquiry system according to claim 7,
wherein the terminal device further includes:
an allergy information memory unit operable to memorize allergy information about a constitution which could develop allergic response to food;
a constitution information acquisition unit operable to acquire information about a consumer's constitution; and
a judgment unit operable to predict and judge the consumer's development of allergic response to the product by referring to the allergy information memorized in the allergy information memory unit based on the acquired information about the consumer's constitution and an ingredient included in the product code read out by the read-out unit.

11. The product information inquiry system according to claim 7,
wherein the terminal device further includes:
a side effect information memory unit operable to memorize side effect information about a constitution which could develop a side effect of a medicine;
a constitution information acquisition unit operable to acquire information about a consumer's constitution; and
a judgment unit operable to predict and judge the consumer's development of a side effect due to the product by referring to the side effect information memorized in the side effect information memory unit based on the acquired information about the consumer's constitution and an ingredient included in the product code read out by the read-out unit.

12. The product information inquiry system according to claim 7,
wherein the product code includes information about recycle of the product or a component of the product,
the product information memory unit memorizes information indicating a scrapping method of the product or the component of the product as the product information along with the corresponding information about recycle, and
the return unit reads out the corresponding information indicating the scrapping method from the product information memory unit and sends the information to the terminal device when the product code is sent from the terminal device.

13. The product information inquiry system according to claim 7,
wherein the product information memory unit memorizes quality information of the product or a component of the product as the product information, and
the return unit reads out the corresponding quality information from the product information memory unit and sends the information back to the terminal device when the product code is sent from the terminal device.

14. The product information inquiry system according to claim 7,
wherein the product code includes information indicating a recommended storage temperature of the product,
the product is equipped with a temperature sensor for detecting a temperature of the product,
the terminal device further includes:
a temperature read-out unit operable to read out the temperature of the product detected by the temperature sensor equipped for the product;
a freshness control unit operable to control freshness of the product by comparing the read-out temperature read out by the temperature read-out unit with the recommended storage temperature.

15. A product information inquiry device that supports inquiry of information about a product,
wherein the product is source-marked with a product code including:
an item code for specifying an item of the product; and
an individual article code for identifying the product uniquely among a group of products belonging to the same item, and
the product information inquiry device comprises:
a read-out unit operable to read out the product code marked on the product;
an allergy information memory unit operable to memorize allergy information about a constitution which could develop allergic response to food;
a constitution information acquisition unit operable to acquire information about a consumer's constitution;
a judgment unit operable to predict and judge the consumer's development of allergic response to the product by referring to the allergy information memorized in the allergy information memory unit based on the acquired information about the consumer's constitution and an ingredient included in the product code read out by the read-out unit.

16. A product information inquiry device that supports inquiry of information about a product,
wherein the product is source-marked with a product code including:
an item code for specifying an item of the product; and
an individual article code for identifying the product uniquely among a group of products belonging to the same item, and
the product information inquiry device comprises:
a read-out unit operable to read out the product code marked on the product;
a side effect information memory unit operable to memorize side effect information about a constitution which could develop a side effect of a medicine;
a constitution information acquisition unit operable to acquire information about a consumer's constitution; and
a judgment unit operable to predict and judge the consumer's development of a side effect due to the product by referring to the side effect information memorized in the side effect information memory unit based on the acquired information about the consumer's constitution and an ingredient included in the product code read out by the read-out unit.

17. A POS system comprising a POS terminal system and a center device which are connected via a communication channel,
wherein a product for sale is marked with an item code for specifying an item of the product and an individual article code for identifying the product uniquely among a group of products belonging to the same item,
the center device includes:
a center side description information holding unit operable to hold description information including a name and a price of the product for sale; and
a resource information holding unit operable to hold resource information per product, that is the information including the product which is specified by a combination of a part of the item code or the entire item code and the individual article code and the corresponding information about resources of the product, and
the POS terminal system includes:
a terminal side description information holding unit operable to receive and hold description information transmitted from the center device;
a read-out unit operable to read out the item code and the individual article code marked on the product;
a reference unit operable to acquire the description information of the product, which is specified by a combination of a part of the item code or the entire item code and the individual article code, by referring to the description information which is held in the terminal side description information holding unit, and acquire the resource information of the product by referring to the resource information which is held in the resource information holding unit of the center device; and
a print unit operable to print the acquired description information and resource information.

18. The POS system according to claim 17 further comprising:
a product data generation device that generates product data including the individual article code and the resource information of the product for manufacturing and sale;
an information service device that is a Web site for providing information by transferring the product data generated by the product data generation device to the center device,
wherein the information service device includes:
a data structure notice unit operable to notify the product data generation device of the data structure of the product data suitable for storage in the center device; and
a resource information service unit operable to receive the product data from the product data generation device and provide the center device with the product data as the resource information, and
the product data generation device generates the product data of the product for manufacturing and sale based on the data structure notified from the information service device, and sends the product data to the information service device.

19. The POS system according to claim 17,
wherein the center device further includes a customer information holding unit operable to hold customer information that is information about a customer,
the POS system further includes an information service device that is a Web site for providing the customer with the resource information held in the center device,
the information service device includes:
a replication information holding unit operable to hold replications of the resource information and the customer information held in the center device;
an authentication unit operable to authenticate the customer who accesses the information service device via the communication channel based on the customer information held in the replication information holding unit; and
a search unit operable to read out the resource information of the product by searching the replication information holding unit for a product specified by a combination of a part of the item code or the entire item code and the individual article code and send the read-out resource information back to the terminal device, when a search request of the resource information along with the combination of the item code and the individual article code is sent from the terminal device of the authenticated customer.

20. The POS system according to claim 17,
wherein the center device further includes:
a customer retail information holding unit operable to hold customer retail information that is information about a customer and retail at the time of selling the product; and
a viewing right information holding unit operable to hold viewing right information that is information about a right for a manufacturer who manufactures the product to view the customer retail information,
the POS system further includes an information service device that is a Web site for providing the manufacturer with the customer retail information held in the center device, and
the information service device includes:
a replication information holding unit operable to hold replications of the customer retail information and the viewing right information held in the center device;
an authentication unit operable to authenticate the manufacturer who accesses the information service device via the communication channel based on the viewing right information held in the replication information holding unit; and
a search unit operable to read out the customer retail information of the product by searching the replication information holding unit for a product specified by the item code and send the read-out customer retail information back to the terminal device, when a search request of the customer retail information along with the item code is sent from the terminal device of the authenticated manufacturer.

21. A POS system for a product on which an item code for specifying an item of the product and an individual article code for identifying the product uniquely among a group of products belonging to the same item are marked, the system comprising:
a center device that provides a POS terminal device with information about the product;
a product data generation device that generates product data including the individual article code and resource information that is information about resources of the product for manufacturing and sale; and
an information service device that is a Web site which provides the center device with information by transferring the product data generated by the product data generation device to the center device,
wherein the information service device includes:
a data structure notice unit operable to notify the product data generation device of the data structure of the product data suitable for storage in the center device;
a resource information service unit operable to receive the product data from the product data generation device and provide the center device with the product data as the resource information, and
the product data generation device generates the product data of the product for manufacturing and sale based on the data structure notified from the information service device.

22. A POS system for a product on which an item code for specifying an item of the product and an individual article code for identifying the product uniquely among a group of products belonging to the same item are marked, the system comprising:
a center device that holds resource information that is information about resources of the product and customer information that is information about a customer; and
an information service device that is a Web site for providing the customer with the resource information held in the center device,
wherein the information service device includes:
a replication information holding unit operable to hold replications of the resource information and the customer information held in the center device;
an authentication unit operable to authenticate the customer who accesses the information service device via the communication channel based on the customer information held in the replication information holding unit; and
a search unit operable to read out the resource information of the product by searching for the resource information of a product specified by a combination of a part of the item code or the entire item code and the individual article code and send the read-out resource information back to the terminal device, when a search request of the resource information along with the combination of the item code and the individual article code is sent from the terminal device of the authenticated customer.

23. A POS system comprising:
a center device that holds customer retail information that is information about a customer and retail at the time of selling the product; and
an information service device that is a Web site for providing an manufacturer with the customer retail information held in the center device,
wherein the center device includes a viewing right information holding unit operable to hold viewing right information that is information about a right for the manufacturer who manufactures the product to view the customer retail information, and
the information service device includes:
a replication information holding unit operable to hold replications of the customer retail information and the viewing right information held in the center device;
an authentication unit operable to authenticate the manufacturer who accesses the information service device via a communication channel based on the viewing right information held in the replication information holding unit; and
a search unit operable to read out the customer retail information of the product by searching the replication information holding unit for a product specified by the item code and send the read-out customer retail information back to the terminal device, when a search request of the customer retail information along with the item code is sent from the terminal device of the authenticated manufacturer.
